(19) United States
(12) Patent Application Publication
(10) Pub. No.: US 2001/0017450 A1
(43) Pub. Date: Aug. 30, 2001

(54) Foldable handle mechanism for scooter

(76) Inventor: Jin Chen Chuang, Fong Yuan City (TW)

Correspondence Address: CHARLES E. BAXLEY, 5th Floor, 59 John Street, New York, NY, 10038, US

(21) Appl. No.: 09/749,859

(22) Filed: Dec. 29, 2000

(30) Foreign Application Priority Data
Feb. 25, 2000 (CN) 089203273

(51) Int. Cl. B62M 1/00; B62K 15/00

(52) U.S. Cl. 280/87.041; 280/87.05; 280/655.1

(57) ABSTRACT

A scooter includes a handlebar having a lower portion slidably and pivotally secured to a board with a shaft. A rod is secured to the handlebar and biased to engage with either of two depressions of the board for securing the handlebar to the board at either an upright working position or a downward folding position. A lock device may selectively engage with the board and the handlebar to for lock the handlebar to the board at either the upright working position or the downward folding position, for preventing the handlebar from being folded relative to the board inadvertently.

### BACKGROUND OF THE INVENTION

1. Field of the Invention

The present invention relates to a scooter, and more particularly to a scooter having a solid folding configuration.

2. Description of the Prior Art

Typical scooters have been widely developed and used today and include a handle extended upwardly from a board that is provided for supporting the users. The handles of the most typical scooters may not be folded relative to the board and thus may not be suitably folded and stored for transportation purposes.

U.S. Pat. No. 6,120,044 to Tsai discloses one of the typical scooters including a handle that may be folded relative to the board and that may be selectively secured or locked to the board with a latch device. However, the latch device may be inadvertently actuated or stepped or kicked and may be released such that the handle may be folded relative to the board while in use. This is dangerous for the riders, in which most of the riders are children who may be easily damaged or hurt when the handle is folded relative to the board inadvertently.

The present invention has arisen to mitigate and/or obviate the afore-described disadvantages of the conventional scooters.

### SUMMARY OF THE INVENTION

The primary objective of the present invention is to provide a scooter including a solid folding configuration for preventing the handle from being folded inadvertently and for preventing the riders from being hurt inadvertently.

In accordance with one aspect of the invention, there is provided a scooter comprising a board including a front portion having at least one first depression and at least one second depression formed therein, a handlebar including a lower portion slidably and pivotally secured to the front portion of the board with a pivot shaft, for allowing the handlebar to be moved relative to the shaft and to be rotated relative to the shaft between an upright working position and a downward folding position, a rod secured to the lower portion of the handlebar for engaging with either the first depression or the second depression of the board, means for biasing the rod to engage with either the first depression or the second depression of the board and to secure the handlebar to the board at either the upright working position or the downward folding position, and means for locking the handlebar to the board at either the upright working position or the downward folding position.

The front portion of the board includes at least one frame disposed thereon and having the first depression or the second depression of the board formed therein. The frame includes a swelling provided thereon and located between the first depression and the second depression for defining the least one first depression and the second depression of the board.

The lower portion of the handlebar includes an oblong hole formed therein for slidably receiving the shaft, and for allowing the handlebar to be moved relative to the shaft.

The locking means includes a lock device for selectively engaging with the board and the handlebar in order to lock the handlebar to the board. The front portion of the board includes at least one frame disposed thereon and having at least one first lock cavity and at least one second lock cavity formed therein for receiving the lock device.

The frame includes an opening formed therein and a bulge extended inward of the opening of the frame for defining the first lock cavity and the second lock cavity of the frame. The handlebar includes a block for engaging with the lock device and for locking the handlebar to the board. The block includes two orifices formed therein for selectively engaging with the lock device.

The rod includes two ends, and two pads secured onto the ends of the rod respectively for engaging with either the first depression or the second depression of the board.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a scooter in accordance with the present invention;

FIG. 2 is a partial exploded view of the scooter;

FIG. 3 is a side schematic view of the scooter; and

FIGS. 4 and 5 are enlarged partial side schematic views illustrating the folding operation of the scooter.

### DETAILED DESCRIPTION OF THE PREFERRED EMBODIMENT

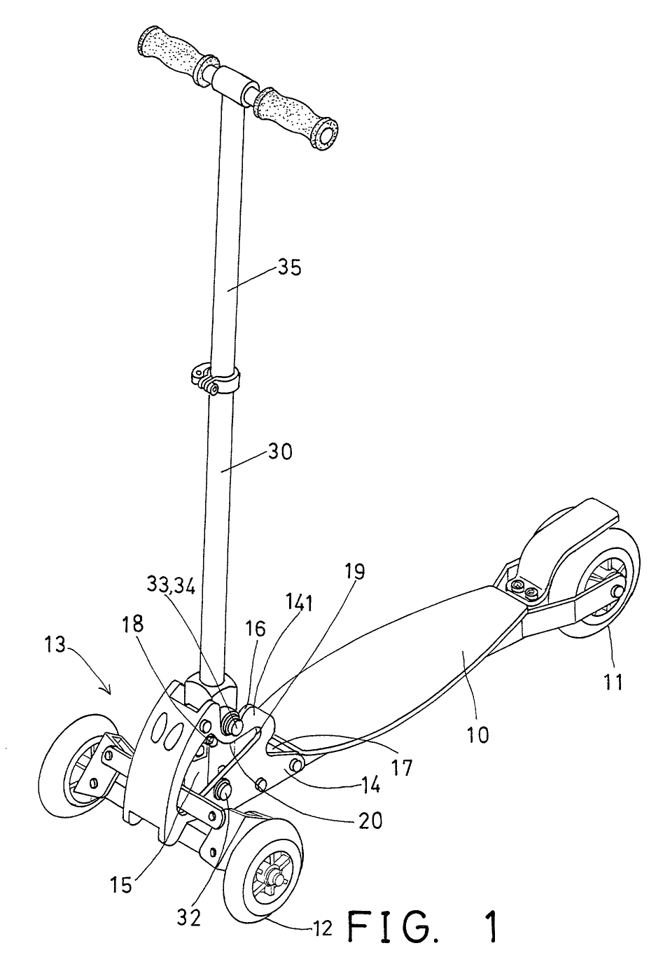

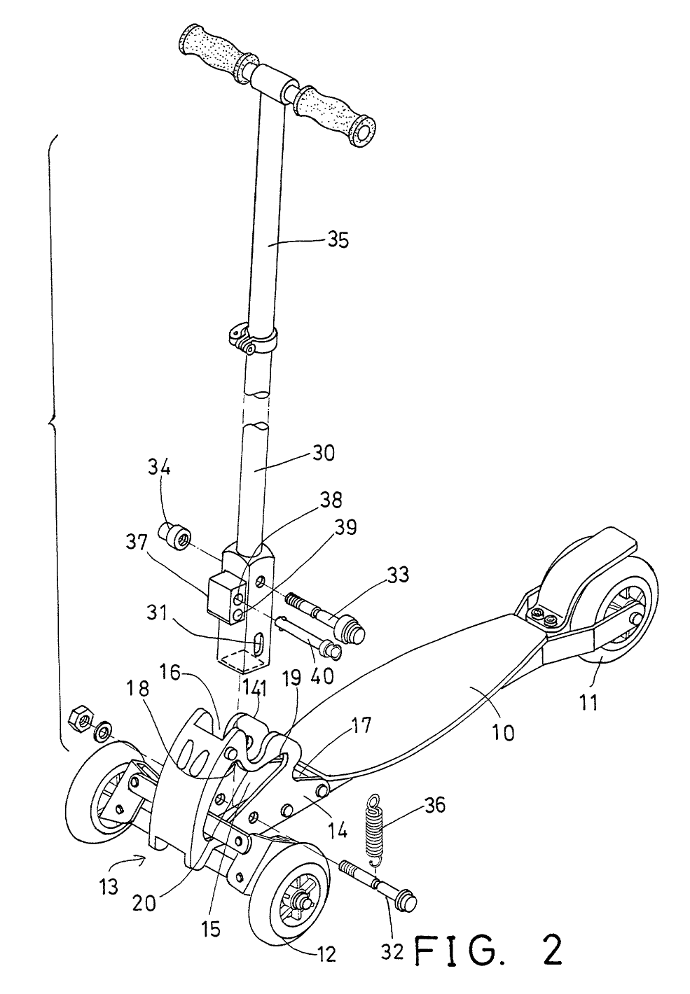

Referring to the drawings, and initially to FIGS. 1-3, a scooter in accordance with the present invention comprises a board 10 including one or more wheels 11 attached to the rear portion thereof and including one or more wheels 12 attached to the front portion 13 thereof for allowing the board 10 to be easily moved by the riders. The wheels 12 may be coupled to the front portion 13 of the board 10 with a steering mechanism or the like, which is not related to the present invention and will not be described in further details.

The front portion 13 of the board 10 includes one or more, particularly two frames 14 secured and provided thereon, and each having an opening 15 formed therein, and each having one or more, particularly two depressions 16, 17 formed in the upper and rear portion thereof and defined by a swelling 141, and each having one or more, particularly two lock cavities 18, 19 formed in the inner portion thereof and defined by a bulge 20 that is extended and/or curved inward of the opening 15 of the frame 14 respectively.

A handlebar 30 includes an oblong hole 31 formed in the lower portion thereof for slidably receiving a shaft 32 which is secured to the frames 14 or the front portion of the board 10. The oblong hole 31 is formed or extended longitudinally in the handlebar 30 such that the handlebar 30 may be moved upward and downward relative to the shaft 32 and thus the board 10 with the sliding engagement of the shaft 32 in the oblong hole 31 of the handlebar 30. The handlebar 30 may include an extension 35 slidably engaged in the upper portion thereof and adjustably secured thereto with a fastener or the like for allowing the handlebar 30 to be adjusted to different lengths.

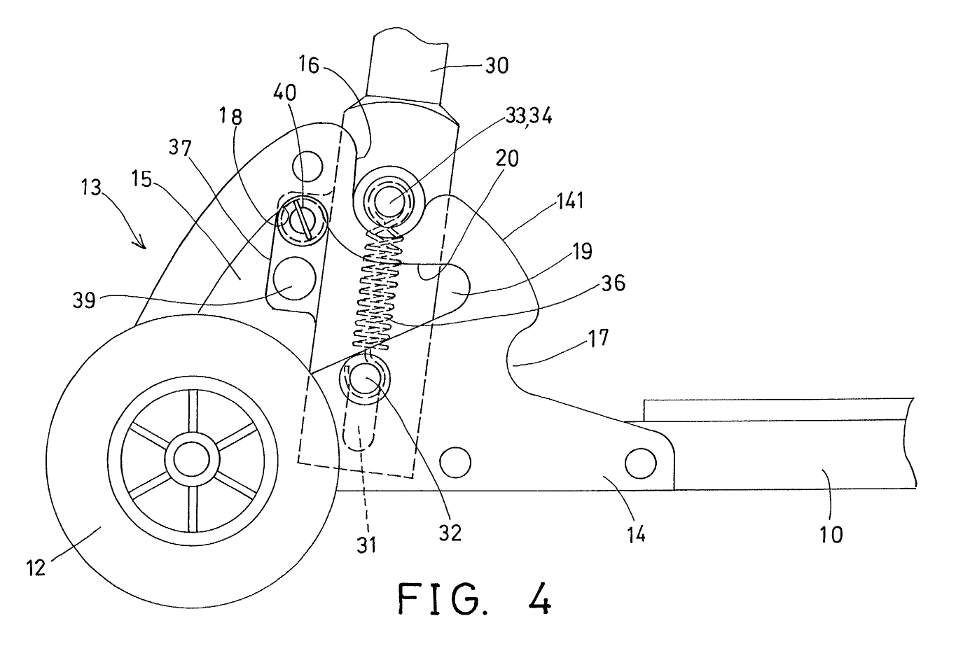

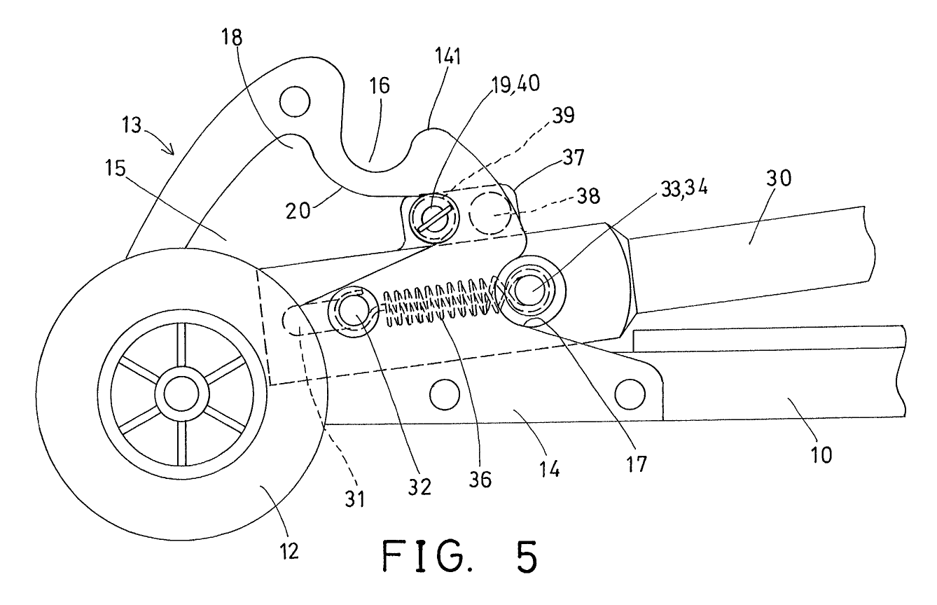

A rod 33 is secured to the lower portion of the handlebar 30 and includes two ends that are preferably extended outward of the handlebar 30. Two caps or pads 34 are secured onto the ends of the rod 33 by such as the threaded engagement, and are extended outward of the handlebar 30 for engaging in either of the depressions 16, 17 of the frames 14 (FIGS. 4, 5). A biasing member or a spring 36 is secured between the shaft 32 and the rod 33 for biasing the handlebar 30 downward or toward the shaft 32 and for forcing the rod 33, particularly the ends or the pads 34 of the rod 33 to engage with the depressions 16, 17 of the frames 14.

The handlebar 30 includes a block 37 secured thereto or extended therefrom and having one or more orifices 38, 39 formed therein for receiving a fastener or a lock device 40, such as a lock pin 40, which may be engaged in either of the lock cavities 18, 19 of the frames 14 (FIGS. 4, 5) for locking the handlebar 30 to the frames 14 and for preventing the handlebar 30 from being rotated relative to the frames 14 and thus the board 10.

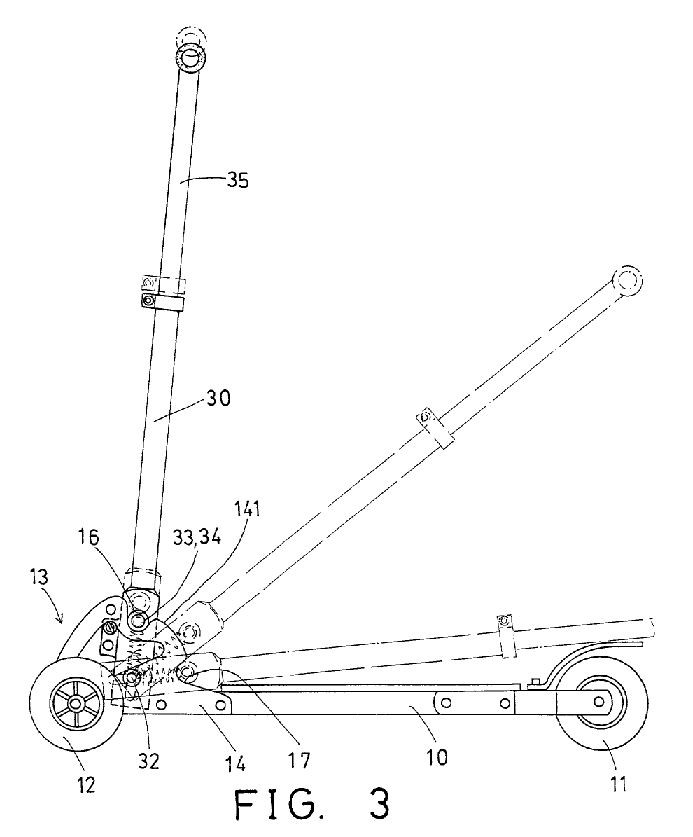

In operation, as shown in FIG. 3, the handlebar 30 is rotatable relative to the board 10 between an upright working position (FIGS. 1, 4) and a downward folding position (FIG. 5). The spring 36 may bias the rod 33 toward the shaft 32 in order to force the rod 33 or the pads 34 to engage with either of the depressions 16, 17 of the frames 14 and so as to lock the handlebar 30 to the board 10 either at the upright working position or at the downward folding position. The handlebar 30 may be moved or pulled relative to the board 10 against the spring 36 such that the rod 33 and the pads 34 may be moved or disengaged from one of the depressions 16 or 17 of the frames 14 and may be moved over the swelling 141 in order to engage with the other depression 17 or 16 of the frames 14. The sliding engagement of the shaft 32 in the oblong hole 31 of the handlebar 30 may limit the sliding movement of the handlebar 30 relative to the board 10 and the frames 14.

As shown in FIG. 4, when the rod 33 and the pads 34 are engaged in the depressions 16 of the frames 14, the handlebar 30 may not be moved or pulled toward the shaft 32 due to the engagement of the pads 34 in the depressions 16 of the frames 14. The lock device 40 may engage with the handlebar 30, or the block 37 of the handlebar 30, and may engage into either of the orifices 38, 39 of the block 37 and may prevent the handlebar 30 from moving away from the shaft 32, such that the lock device 40 may lock the handlebar 30 to the frames 14 at the upright working position.

As shown in FIG. 5, when the rod 33 and the pads 34 are engaged in the other depressions 17 of the frames 14, the handlebar 30 also may not be moved or pulled toward the shaft 32 due to the engagement of the pads 34 in the depressions 17 of the frames 14. The lock device 40 may now engage with the handlebar 30, or the block 37 of the handlebar 30, and may engage into either of the orifices 38, 39 of the block 37 and may prevent the handlebar 30 from moving away from the shaft 32, such that the lock device 40 may lock the handlebar 30 to the frames 14 at the downward folding position.

When the handlebar 30 is locked to the frames 14 either at the upright working position or at the downward folding position, the handlebar 30 may not be pulled away from the shaft 32 against the spring 36, such that the handlebar 30 will not be folded relative to the board 10 inadvertently. The handlebar 30 may be pulled away from the shaft 32 against the spring 36, and the rod 33 and the pads 34 may be moved over the swelling 141 to engage with either of the depressions 16, 17 only when the lock device 40 is disengaged from the block 37 or the handlebar 30.

Accordingly, the scooter in accordance with the present invention includes a solid folding configuration for preventing the handle from being folded inadvertently and for preventing the riders from being hurt inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A scooter comprising:
a board including a front portion having at least one first depression and at least one second depression formed therein,
a handlebar including a lower portion slidably and pivotally secured to said front portion of said board with a pivot shaft, for allowing said handlebar to be moved relative to said shaft and to be rotated relative to said shaft between an upright working position and a downward folding position,
a rod secured to said lower portion of said handlebar for engaging with either said at least one first depression or said at least one second depression of said board,
means for biasing said rod to engage with either said at least one first depression or said at least one second depression of said board and to secure said handlebar to said board at either said upright working position or said downward folding position, and
means for locking said handlebar to said board at either said upright working position or said downward folding position.

2. The scooter according to claim 1, wherein said front portion of said board includes at least one frame disposed thereon and having said at least one first depression or said at least one second depression of said board formed therein.

3. The scooter according to claim 2, wherein said at least one frame includes a swelling provided thereon and located between said at least one first depression and said at least one second depression for defining said least one first depression and said at least one second depression of said board.

4. The scooter according to claim 1, wherein said lower portion of said handlebar includes an oblong hole formed therein for slidably receiving said shaft, and for allowing said handlebar to be moved relative to said shaft.

5. The scooter according to claim 1, wherein said locking means includes a lock device for selectively engaging with said board and said handlebar in order to lock said handlebar to said board.

6. The scooter according to claim 5, wherein said front portion of said board includes at least one frame disposed thereon and having at least one first lock cavity and at least one second lock cavity formed therein for receiving said lock device.

7. The scooter according to claim 6, wherein said at least one frame includes an opening formed therein and a bulge extended inward of said opening of said at least one frame for defining said at least one first lock cavity and said at least one second lock cavity of said at least one frame.

8. The scooter according to claim 5, wherein said handlebar includes a block for engaging with said lock device and for locking said handlebar to said board.

9. The scooter according to claim 8, wherein said block includes two orifices formed therein for selectively engaging with said lock device.

10. The scooter according to claim 1, wherein said rod includes two ends, and two pads secured onto said ends of said rod respectively for engaging with either said at least one first depression or said at least one second depression of said board.
